(19) United States
(12) Patent Application Publication
(10) Pub. No.: US 2013/0151971 A1
(43) Pub. Date: Jun. 13, 2013

(54) SERVER APPARATUS AND PROCESSING METHOD FOR THE SAME

(71) Applicant: Olympus Imaging Corp., Tokyo (JP)

(72) Inventor: Toshiaki WADA, Tokyo (JP)

(73) Assignee: OLYMPUS IMAGING CORP., Tokyo (JP)

(21) Appl. No.: 13/712,147

(22) Filed: Dec. 12, 2012

(30) Foreign Application Priority Data
Dec. 13, 2011 (JP) 2011272621

(51) Int. Cl. G06F 3/048

(52) U.S. Cl. CPC G06F 3/048
USPC 715/723

(57) ABSTRACT

A server apparatus is provided with a memory unit to store at least one content; an editing unit to produce video data by editing a material which is including at least one motion picture and is uploaded through a network and the content stored in the memory unit, in accordance with the information indicating editing operation of a user in a terminal apparatus connected to the network; and a quality reducing unit to produce a low-quality content by reducing quality of a high-quality original content stored in the memory unit. The editing unit produces first video data by editing the material and the low-quality content, and then produces second video data including the material and the original content of the low-quality content.

### FIELD OF THE INVENTION

The present invention relates to a server apparatus and a processing method for such a server apparatus.

### BACKGROUND OF THE INVENTION

When releasing motion pictures shot by a camera to the public unlike the case of still pictures, it cannot often bear to see unless the motion pictures are edited to be improved up to a point. When editing motion pictures (video data), it is not rare that copyrighted pay content is added (e.g. music), in addition to cut-and-paste editing of shot image. Generally, even in the case where only a part of pay content is used, it is necessary to purchase the entire content. In the meantime, when releasing motion pictures produced by such editing as a video product on a Web page, the producer needs to pay royalties of the content. Moreover, it becomes a burden upon the producer to purchase all the contents tested at the time of the editing regardless of whether or not the contents are used for ultimately the finished video product.

Japanese Patent Application Laid-Open Publication No. 2004-118324 discloses a system for managing propriety of secondary use for every part of contents divided for the purpose of secondary use. Moreover, use of certain parts thereof is allowed without charge.

### SUMMARY OF THE INVENTION

A server apparatus according to one embodiment of this invention is for editing a motion picture received through a network. The server apparatus comprises: a communication unit to transmit and receive information with regard to editing through the network; a memory unit to store at least one content; an editing unit to produce video data by editing a material which is including at least one motion picture and is uploaded through the network and the content stored in the memory unit, in accordance with the information indicating editing operation of a user in a terminal apparatus connected to the network; and a quality reducing unit to produce a low-quality content by reducing quality of a high-quality original content stored in the memory unit. The editing unit produces first video data by editing the material and the low-quality content, and then produces second video data including the material and the original content of the low-quality content.

A method according to another embodiment of this invention is for producing a video product in a server apparatus connected to a terminal apparatus through a network. The method comprises: an uploading step of uploading a material including at least one motion picture to the server apparatus through the network; a selecting step of selecting a desired original content from a list of contents stored beforehand in the server apparatus in accordance with operation by a user on the terminal apparatus; an editing step of producing first video data by editing the material and a low-quality content generated from the selected original content in accordance with operation by the user on the terminal apparatus; and a combining step of producing second video data corresponding to the first video data by combining the material used for the first video data with the original content which is a source of the low-quality content in accordance with operation by the user on the terminal apparatus.

### BRIEF DESCRIPTION OF THE DRAWINGS

FIG. 1 is a diagram for explaining a brief overview of operation of the whole of a service system.

FIG. 2 is a block diagram showing a configuration of a camera as the imaging device.

FIG. 3 is a block diagram showing a configuration of a terminal apparatus.

FIG. 4 is a block diagram showing a configuration of a service server in a server apparatus.

FIG. 5 is a diagram showing a configuration of an external storage in the server apparatus.

FIG. 6 is a diagram showing a structure of a member management database (DB).

FIG. 7 is a diagram showing a structure of a content management database (DB).

FIG. 8 is a diagram showing a structure of a product management database (DB).

FIG. 9 is a flow chart showing a procedure of member registration.

FIG. 10 is a flow chart showing a procedure of upload to the service server.

FIG. 11 is a flow chart showing a procedure of producing and releasing of a video product.

FIG. 12 is a flow chart showing editing processing executed by a video editing unit in the service server.

### DESCRIPTION OF THE PREFERRED EMBODIMENTS

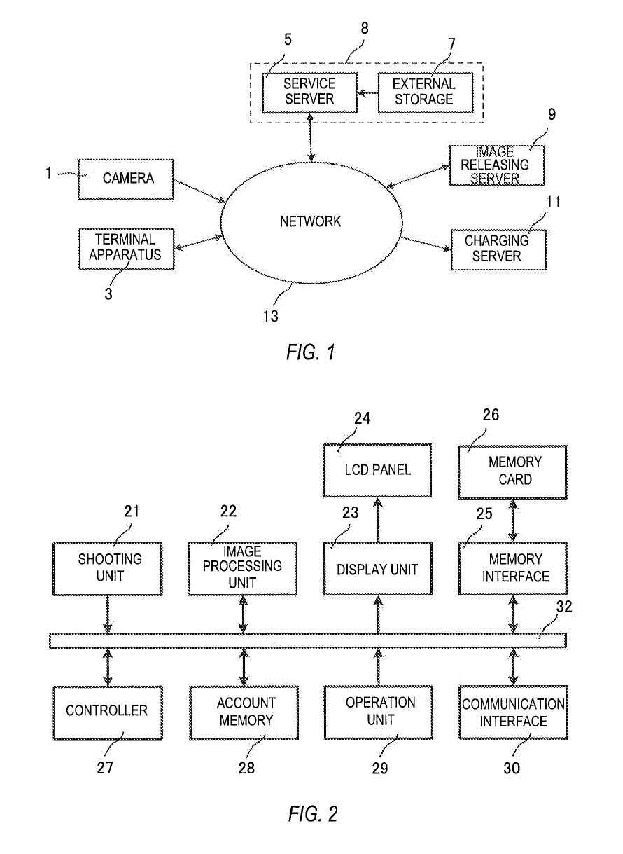

With reference to FIG. 1, there is described a brief overview of operation of the whole of a service system according to an embodiment. The service system includes an electronic camera 1 (hereinafter, referred to as a camera), a terminal apparatus 3, a service server 5, an image releasing server 9, a charging server 11, and a network 13 for mutually connecting these components. One example of the network 13 is the Internet. The service server 5 provides service of motion picture editing etc. for member, and is connected to an external storage 7. As an example, the charging server 11 may be a server of settlement service provider (e.g. a credit card company), and the image releasing server 9 may be a server for providing a video sharing website on the Internet. The service server 5 and the external storage 7 compose a server apparatus 8.

The camera 1 transmits a motion picture shot by the camera 1 to the service server 5 in accordance with member's (or user's) operation, and the external storage 7 as a memory unit stores this motion picture through the service server 5. The service server 5 produces video data corresponding to a video product to be released to the public by editing the motion picture. At this time, the service server 5 uses a copyrighted pay content (original content) (e.g. music and an illustration) stored in a content library (content database) 83a of the external storage 7. When the video product is released to the public, the service server 5 notifies the terminal apparatus 3 used for the member that a license fee (usage fee) of the copyrighted content used for the video product is charged. When the terminal apparatus 3 transmits, to the service server 5, the signal (information) indicating that the member agrees to be charged, the service server 5 transmits the video product with license information of the copyrighted content to the image releasing server 9, and then release the video product through the image releasing server 9, meanwhile the service server 5 transmits member information (e.g., information including an account number etc.) and information on charged amount to the charging server 11 in order to settle the account. The image releasing server 9 may be included in the server apparatus 8.

FIG. 2 is a block diagram showing a configuration of the camera 1 as an imaging device. The camera 1 is a still camera or a video camera which can shoot a motion picture. The camera 1 includes a communication function to function also as an image transmitting device. The camera 1 is connected to the network 13 through an access point via wireless local area network (LAN) (e.g. Wireless Fidelity (Wi-Fi)), for example. The camera 1 having the communication function may be a cellular phone with an electronic camera function, and may be connected to the network 13 through a mobile phone network in this case. If the camera 1 does not have such a communication function, other image transmitting devices having a communication function (e.g. a computer which can access the Internet) may receive the motion picture shot by the camera 1, and transmit the received motion picture as a motion picture file to the service server 5.

The camera 1 includes an imaging unit 21, an image processing unit 22, a display unit 23, a memory interface 25, a controller 27, an account memory 28, an operation unit 29, and a communication interface 30, and these components are electrically connected through a bus 32 to each other. The display unit 23 is electrically connected to a liquid crystal display panel (LCD panel) 24, and the memory interface 25 is electrically connected to a memory card 26.

The imaging unit 21 includes a photographic lens, an image sensor, etc., and obtains image data. The image processing unit 22 executes processing of gamma correction, color conversion, demosaicing, compressing and decompressing, etc. to the image data. The image processing unit 22 may be composed of a central processing unit (CPU), an arithmetic processing circuit (e.g. an application-specific integrated circuit (ASIC), or a field-programmable gate array (FPGA)), for example. The image processing unit 22 may also output image data to be displayed to the display unit 23. The display unit 23 displays, on the liquid crystal display panel 24, image based on the image data output from the image processing unit 22, and a menu for setting various functions of the camera 1. The memory interface 25 is an interface for establishing connection with the memory card 26. The memory card 26 stores compressed image data, for example. The controller 27 controls the imaging unit 21, the image processing unit 22, the display unit 23, the memory interface 25, the account memory 28, and the operation unit 29. The account memory 28 stores an identifier (ID) for authenticating a user who uses the camera 1 as a member by the service server 5, and an address of the camera 1 on the network 13. The operation unit 29 is composed a button etc. used in order that the user may operate the camera 1. The communication interface 30 is an interface used in order that the camera 1 may be connected to the network 13 and then may communicate with apparatuses (e.g. a server) on the network 13.

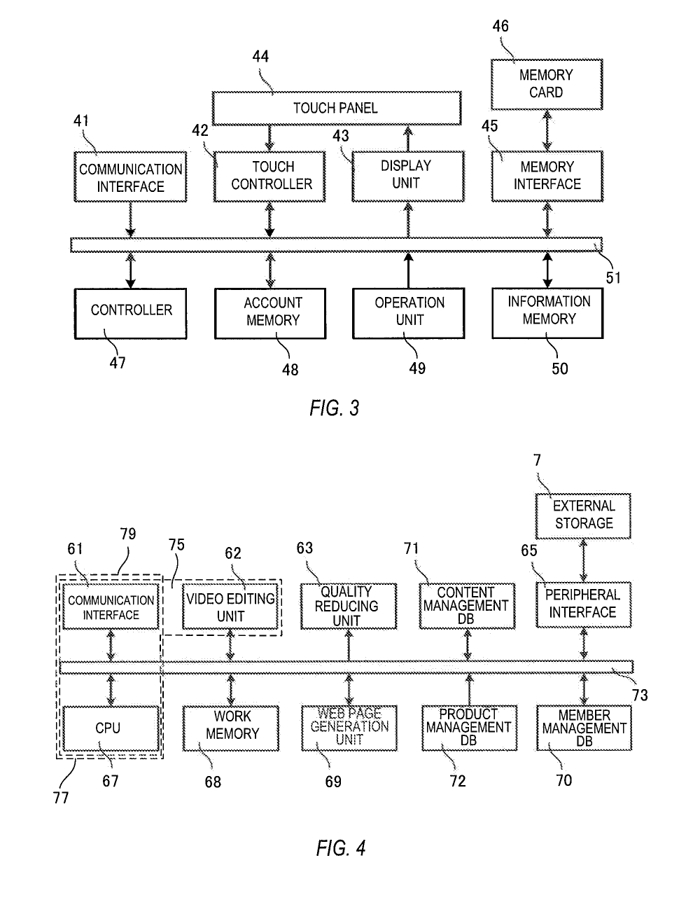

FIG. 3 is a block diagram showing a configuration of the terminal apparatus 3. The terminal apparatus 3 is a personal computer or a mobile terminal, for example, but is illustrated as a mobile terminal herein. The terminal apparatus 3 includes a communication interface 41, a touch panel controller (touch controller) 42, a display unit 43, a memory interface 45, a controller 47, an account memory 48, an operation unit 49, and an information memory 50, and these components are electrically connected through the bus 51 to each other. The touch panel controller 42 and the display unit 43 are electrically connected to the touch panel 44, and the memory interface 45 is electrically connected to a memory card 46.

The communication interface 41 is an interface used in order that the terminal apparatus 3 may be connected to the network 13 and may communicate with apparatuses (e.g. a server) on the network 13. The touch panel 44 is composed of a liquid crystal display panel for displaying text and images, and a sensor for detecting a pressed position on a surface of the liquid crystal display panel. The touch panel 44 is used for presenting information to a user who operates the terminal apparatus 3, and inputting instructions from the user. The touch panel controller 42 detects an operative position (e.g. a position pressed or contacted with a finger or a pen) on the touch panel 44, for example, and outputs the detected operative position. The display unit 43 displays a menu for operating various functions of the terminal apparatus 3, for example on the touch panel 44. The memory interface 45 is an interface for establishing connection with the memory card 46. The memory card 46 stores various data. The controller 47 controls the communication interface 41, the touch panel controller (touch controller) 42, the display unit 43, the memory interface 45, the account memory 48, the operation unit 49, and the information memory 50. The controller 47 is composed of a memory for storing data, a memory for storing a predetermined program (e.g. Web browser), a central processing unit (CPU) for executing the predetermined program, etc. The account memory 48 stores an identifier (ID) for authenticating a user who uses terminal apparatus 3 as a member by the service server 5, and an address of terminal apparatus 3 on the network 13. The operation unit 49 is composed of a switch etc. for receiving ON/OFF operation of an electronic power supply, for example, for which touch operation using the touch panel 44 cannot be used. The information memory 50 stores image data, for example.

FIG. 4 is a block diagram showing a configuration of the service server 5 in the server apparatus 8. The service server 5 includes a communication interface 61, a video editing unit 62 (hereinafter, referred to as an editing unit), a quality reducing unit 63, a peripheral device interface (peripheral interface) 65, a central processing unit (CPU) 67, a work memory 68, a Web page generation unit 69, a member management database (DB) 70, a content management database (DB) 71, and a product management database (DB) 72, and these components are electrically connected through a bus 73 to each other. In addition to these components, the service server 5 further includes a display unit (monitor) and a memory (ROM) for storing a program executed by the CPU 67. The editing unit 62, the quality reducing unit 63, and Web page generation unit 69 may be composed respectively of a CPU, an arithmetic processing circuit (e.g. ASIC, FPGA), etc.

The communication interface 61 as a communication unit is an interface used in order that the service server 5 may be connected to the network 13 and may communicate with apparatuses (e.g. a terminal apparatus and a server on the network 13).

The editing unit 62 combines a material including at least one motion picture uploaded by a user using the camera 1 or the terminal apparatus 3, with a content (original content) stored in the external storage 7 and provided by the server apparatus 8, and then produces video data (video product). The material used for the editing includes a motion picture, a still picture, voice data, and text data uploaded by the user itself. In addition to these data, the material used for the editing further includes production data (e.g. a video product already edited by the user itself using the aforementioned editing unit 62), intermediate data stored in the middle of the editing, etc. The content includes a material and production data which registered in the service server 5 by the user for the purpose of releasing to other users, in addition to a pay contents (e.g. music and an illustration) provided by a professional producer. The uploaded material, and the production data and intermediate data produced by editing are stored in the external storage 7.

The editing unit 62 combines a low-quality content of which quality is reduced by the quality reducing unit 63 with the material, and then produces video data (first video data) used for previewing a product in course of editing.

The quality reducing unit 63 produces a low-quality content based on data generated by reducing quality of the pay content (original content) stored in the content library 83a of the external storage 7 as a preparation for the use of the pay content without permission. The editing unit 62 can produce preview video data to be previewed in the terminal apparatus 3, based on the low-quality content. The video data used for previewing includes only the low-quality content, thereby preventing a situation where the high-quality pay content is used without permission. Accordingly, it is allowed that the user tries plenty of preview contents. The user can further try plenty of preview contents by releasing the low-quality content at no charge. The quality reducing unit 63 executes processing for reducing the frequency bandwidth to predetermined width, or processing for compressing irreversibly content data and then decompressing the compressed data, with respect to the data of the content (content data). Image data (e.g. an illustration) may be suitable as the content data, in addition to audio data (e.g. music).

For example, the quality reducing unit 63 is a filter for reducing a frequency bandwidth of the content data (in particular audio data) to a predetermined frequency bandwidth. The quality reducing unit 63 includes a data compression means (data compression unit) for compressing the content data irreversibly, and a data decompression means (data decompression unit) for decompressing the compressed content data. Quality of the content data decompressed after the irreversible compression is reduced compared with quality of the original content data (the content data before the irreversible compression). Note that the quality reducing unit 63 may not reduce the quality of a part of the original content data in order that the quality of the original content data can be known.

The peripheral device interface 65 is an interface for establishing connection with peripheral devices (e.g. the external storage 7). The central processing unit (CPU) 67 is a control unit for controlling operation of the whole of the service server 5. The work memory 68 is used as a work area of the CPU 67, the editing unit 62, the quality reducing unit 63, and the Web page generating unit 69, etc. The Web page generation unit 69 produces data of the Web page (e.g. HTML data) displayed on a Web browser by the terminal apparatus 3. The member management database (DB) 70, the content management database (DB) 71, and the product management database (DB) 72 will be described later.

The CPU 67 as a control unit executes a communication program to establish a session (connection) between the terminal apparatus 3 and the image releasing server 9, and then transmits video data produced in the editing unit 62 to the terminal apparatus 3 or the image releasing server 9 using a predetermined communications protocol through the communication interface 61. For example, the communications protocol is TCP/IP, and the CPU 67 generates IP packets for transmitting the video data. In this embodiment, the editing unit 62, the CPU 67, and the communication interface 61 transmit video data used for previewing (first video data) to the terminal apparatus 3 so that the product in course of the editing can be previewed on the terminal apparatus 3. Moreover, the CPU 67 and the communication interface 61 compose a releasing unit 77 for releasing the video data to be released (second video data) as video product through the network 13.

The CPU 67 executes the communication program to establish a session (connection) with the charging server 11, and transmits member information (e.g. an account number) and information on charged amount including a license fee (usage fee) of the pay content to the charging server 11 using the predetermined communications protocol through the communication interface 61. The CPU 67 and the communication interface 61 compose a charging unit 79 for charging the member for the license fee of the pay content used for producing of the video data to be released. This license fee is calculable by the CPU 67 based on a releasing fee for every content (content ID) registered in the later-described content management database (DB) 71. The charging unit 79 may also charge a predetermined fee for the member for every predetermined period. For a member who has paid a membership fee, the charging unit 79 does not charge the license fee for a low-quality content temporarily used when editing video data in process of the editing in the editing unit 62, but charges a license fee for the pay content (original content) used for the video data released as a video product. For a member who has not paid the membership fee, the charging unit 79 may also charge a predetermined fee for the pay content temporarily used when editing the video data in process of the editing in the editing unit 62.

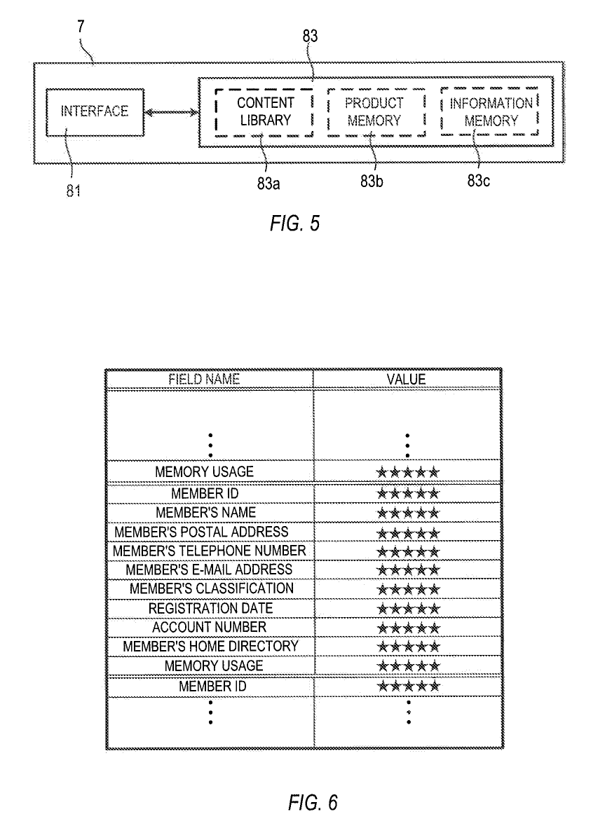

FIG. 5 shows a configuration of the external storage 7 in the server apparatus 8. The external storage 7 (memory unit) is a hard disk drive, for example, and includes an interface 81 for establishing connection with the service server 5, and a recording medium 83. The recording medium 83 includes a content library 83a, a product memory 83b, and an information memory 83c. The content library 83a, the product memory 83b, and the information memory 83c may be respectively an individual recording media. The content library 83a stores a copyrighted content (e.g. music and an illustration), regardless of whether it is a pay content or free content. The product memory 83b stores a video product file in a home directory prepared for every member. The video product file is a file for storing video data in course of the editing or after the editing, and a material and content used for the video data. In addition to a motion picture shot by the camera 1 and then uploaded to the service server 5 by using the camera or other devices, the material also includes data of other formats (e.g. a still image, and audio data, etc.) uploaded by the user. The reason for also including the material in the video product file in addition to the video data in which the material is combined is because re-editing of the video data is possible, even if the material or content is deleted from the server apparatus 8. Other data is stored in the information memory 83c.

FIG. 6 shows a structure of the member management database (DB) 70. One data (record) for every member is composed of a plurality of fields, and includes the following information regarding for every member: a member ID, a member's name, a member's postal address, a member's telephone number, a member's E-mail address, a member's classification, a registration date, an account number, a member's home directory name in the product memory 83b, and memory usage of the product memory 83b for every member. A credit card number may be available as the account number. The data for every member may also include information for identifying whether the member is a free member or a dues-paying member. The dues-paying member is a member for whom a membership fee is charged for every certain period, and the free member is a member for whom such a membership fee is not charged. The information for identifying whether the member is a free member or a dues-paying member is registered in the field of the classification.

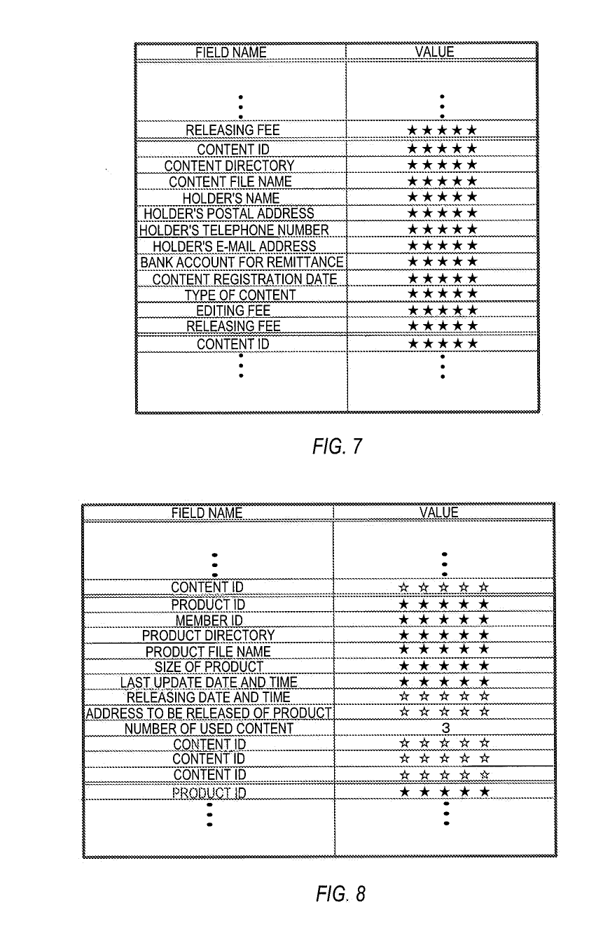

FIG. 7 shows a structure of the content management database (DB) 71. One data (record) for every content is composed of a plurality of fields, and includes the following information on the regarding for every content: a content ID, a content directory in the content library 83a, a content file name, a content owner's (holder's) name and postal address, a content owner's telephone number, a contents owner's E-mail address, a bank account number for remittance of a content usage fee, a content registration date, a type of content, an editing fee (unit price of a license fee for use at the time of editing), and a releasing fee (unit price of a license fee for release to public). A credit card number may be available as the bank account number.

FIG. 8 shows a structure of the product management database (DB) 72. One data (record) for every video product is composed of a plurality of fields, and includes the following information with regard to the product: a product ID, a member ID, a product directory name in the product memory 83b, a product file name, data size of product, a last update date and time, a releasing date and time, a releasing address of product (i.e., an address in the image releasing server 9), the number of content used for product, and a content ID used for product.

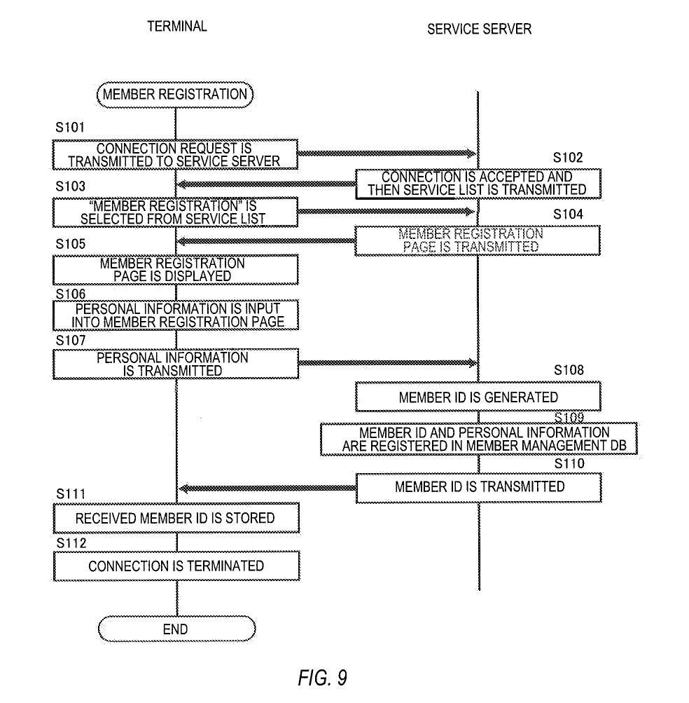

FIG. 9 is a flow chart showing a procedure of a member registration from the terminal apparatus 3 to the service server 5. In the following flow charts, a symbol “S” in reference numerals denotes “Step.”

In S101, the terminal apparatus 3 transmits a connection request to the service server 5. In S102, the service server 5 accepts the connection request, and transmits a service list which is a list of services which can be provided from the service server 5 to the terminal apparatus 3 in a data format which can be displayed by a predetermined program of the terminal apparatus 3. In S103, the user selects “Member Registration” from the service list displayed on the touch panel 44 in the menu format by touching the touch panel 44 of the terminal apparatus 3. The terminal apparatus 3 then transmits information (or signal) indicating that the “Member Registration” is selected to the service server 5 through the network 13.

In S104, the Web page generation unit 69 in the service server 5 which received the information indicating that the “Member Registration” is selected from the terminal apparatus 3 generates data (e.g. HTML data) of the member registration page used for the terminal apparatus 3 of the user for member registration, and then the service server 5 transmits the generated data to the terminal apparatus 3. In S105, the terminal apparatus 3 which received the member registration page displays the received member registration page on the liquid crystal display panel of the touch panel 44 by the predetermined program (e.g. a Web browser) executed by the controller 47. In S106, the user performs touch operation of the touch panel 44 on which the member registration page is displayed, and then inputs personal information. Next, in S107, the terminal apparatus 3 transmits the personal information to the service server 5 through the communication interface 41 in response to the user touching a transmission button in the member registration page displayed on the touch panel 44.

The service server 5 which received the personal information generates a member ID through the CPU 67 in S108, and then registers information, including the member ID, member's personal information (e.g. a member's name, a member's postal address, a member's telephone number, a member's E-mail address, and account number), etc., into the member management database 70 through the CPU 67 in S109 (Member registration step). Next, in S110, the service server 5 transmits the member ID to the terminal apparatus 3. In S111, the terminal apparatus 3 which received the member ID stores the received member ID in the account memory 48. In S112, the terminal apparatus 3 then terminates the connection with the service server 5.

The member ID stored in the account memory 48 in the terminal apparatus 3 at S111 is used for authentication in the case where the member accesses the service server 5 by using a certain information processing apparatus. Accordingly, a duplicate of the member ID is stored in the account memory 28 in the camera 1 by using cable communications, radio communications, or a memory card so that the camera 1 can establish connection with the service server. Moreover, although the above description has stated the procedure of the member registration using the terminal apparatus 3, it is needless to say that the member registration can also be achieved by using the camera 1.

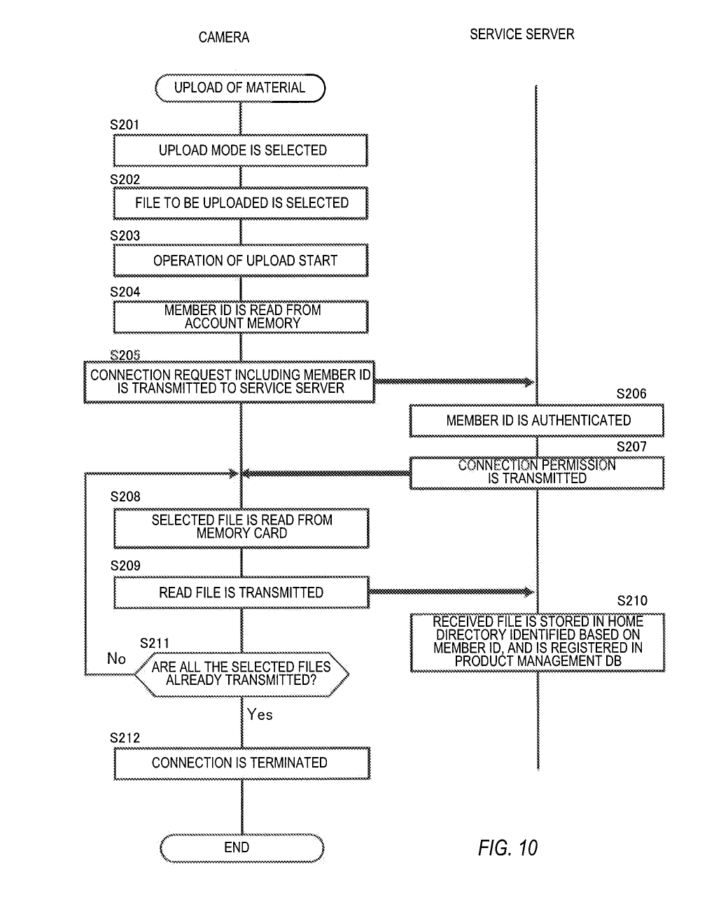

FIG. 10 is a flow chart showing a procedure for uploading the data composing the video product, such as motion picture data shot by the camera 1 as a material to the service server 5.

The camera 1 detects that an upload mode is selected by a user (i.e., member) through operation of the operation unit 29 from a menu displayed on the display unit 23 (S201). The camera identifies a file of material to be uploaded selected by the user from files stored in the memory card 26 in S202, and detects operation for instructing a start of upload by the user through the operation unit 29 in S203. The camera 1 reads a member ID from the account memory 28 in S204, and transmits a connection request including information on the member ID to the service server 5 in S205.

In S206, the service server 5 authenticates the member ID included in the received connection request. In the authentication, it is determined whether the received member ID is already registered in the member management database 70. If the member ID is already registered in the member management database 70, the service server 5 transmits connection permission to the camera 1, in S207. In S208, the camera 1 reads the material file selected in S202 from the memory card 26. In S209, the camera 1 transmits the read material file to the service server 5. In S210, the service server 5 stores the received material file in a home directory identified based on the member ID in the member management database (DB) 70 (Storing step). The camera 1 determines whether all the selected files are transmitted to the service server 5 in S211. If the camera 1 determines that all the selected files are not transmitted thereto, the camera 1 repeats processing of S208 and S209. On the other hand, if the camera 1 determines that all the selected files are transmitted thereto, the camera 1 terminates the connection with the service server 5 in S212.

Although the above description has stated the procedure for uploading the motion picture data etc. shot by the camera 1 to the service server 5, it is needless to say that the motion picture data etc. shot by the camera 1 may be uploaded from other accessible device storing the motion picture data etc. to the service server 5 through the network 13.

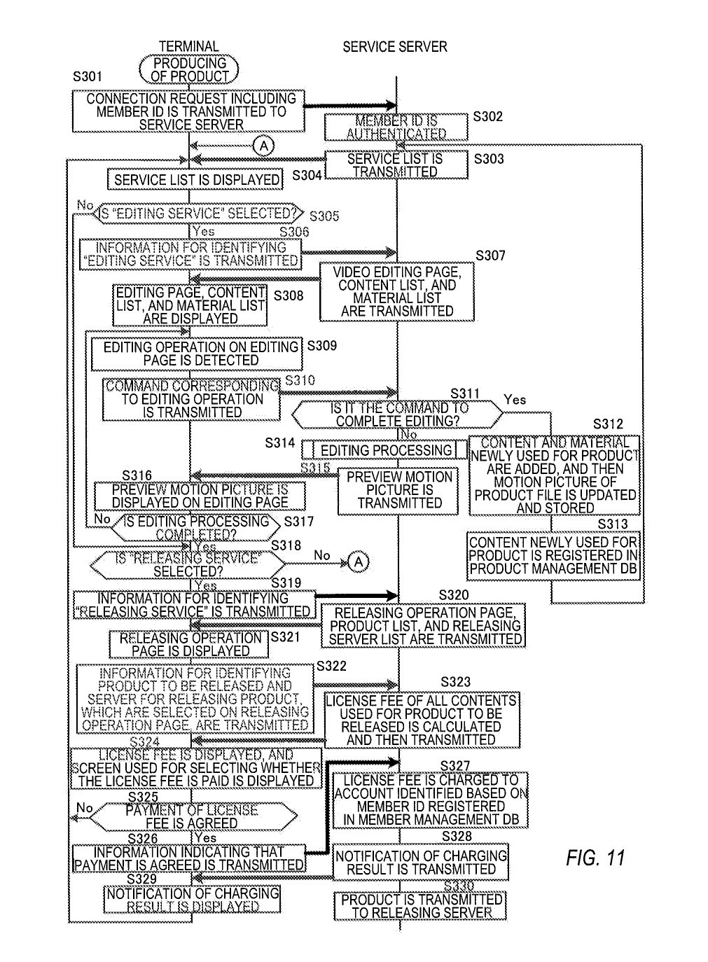

FIG. 11 is a flow chart showing a procedure of producing and releasing of a video product. In S301, the terminal apparatus 3 transmits a connection request including information on the member ID to the service server 5. In S302, the service server 5 authenticates the member ID included in the received connection request. If the received member ID is already registered in the member management database 70, in S303, the service server 5 transmits a list of service which can be provided by the server apparatus 8 to the terminal apparatus 3 in a data format which can be displayed by a predetermined program (e.g. a Web browser) of the terminal apparatus 3. In S304, the terminal apparatus 3 displays the received service list on the touch panel 44 as a menu so that the user can select the service.

In S305, the terminal apparatus 3 determines whether “Editing Service” is selected from the service list displayed as a menu on the touch panel 44. If the “Editing Service” is selected, the processing goes to S306. If the “Editing Service” is not selected, the processing goes to S318. In S306, the terminal apparatus 3 transmits information (or signal) indicating that the “Editing Service” is selected to the service server 5. In S307, the service server 5 transmits, to the terminal apparatus 3, an editing page used for the editing of the video product, a contents list which is a list of contents registered in the content management database (DB) 71, and a material list which is a list of materials already uploaded by the user, in a data format which can be displayed by the predetermined program of the terminal apparatus 3 (Web page transmission step). The predetermined program may be a Web browser which can reproduce a motion picture or may be a Web browser into which a plug-in which can reproduce the motion picture is built, for example.

In S308, the controller 47 in the terminal apparatus 3 executes the predetermined program, and displays the editing page, the content list, and the material list on the touch panel 44 through the display unit 43. In S309, the predetermined program detects an editing operation input from the touch panel 44 or the operation unit 49 by the user with respect to the editing page. The editing operation is an operation on the editing page by the user, such as selecting the motion picture which becomes a base for the editing page from the material list displayed on the touch panel 44, and instructing to combine and edit the motion picture, with other material and content. In S310, the predetermined program transmits a command corresponding to the editing operation to the service server 5. In S311, the service server 5 which received this command determines whether the received command is a command to complete the editing. If the result of the determination in S311 is “YES (affirmation)”, the processing goes to S312. On the other hand, if the result of the determination in S311 is “NO (negation)”, the processing goes to S314.

In S312, the video editing unit 62 in the service server 5 produces/updates a video product file of the motion picture. In the case of producing a video product file, the video editing unit 62 generates a video product file including the produced video data, the material and the content used for the video data. In the case of updating the video product file, the video editing unit 62 generates the video product file by updating the video data and adding the material and the content newly combined on the video data. Then, the video editing unit 62 stores the generated video product file in the product memory 83b (Producing step). In this case, the material newly used for the video product is a material (or video product) read by the editing unit 62 from the product memory 83b for the purpose of the editing (produce) of the video data in the after-mentioned 5404. The content newly used for the video product is a pay content or free content read by the editing unit 62 from the content library 83a for the purpose of the editing (produce) of the video data in the after-mentioned 5406. In S313, the service server 5 updates/registers the content used for the video data produced or updated in S312 into a record corresponding to the video product in the product management database (DB) 72. Subsequently, the processing returns to S303.

In S314, the editing unit 62 in the service server 5 executes editing processing described later as a process of the editing (Editing step). In S315, the service server 5 transmits a preview motion picture used for previewing the video data in course of the editing, to the terminal apparatus 3. In S316, the terminal apparatus 3 displays the preview motion picture on the editing page. Here, the terminal apparatus 3 displays the preview motion picture of the latest video data transmitted from the service server 5. In S317, the terminal apparatus 3 determines whether or not the user's editorial operation is completed. That is, the terminal apparatus 3 determines whether or not the command to complete the editing is transmitted in S310.

In S318, the terminal apparatus 3 determines whether or not “Releasing Service” is selected from the service list. If the “Releasing Service” is not selected, the processing returns to S304. If the “Releasing Service” is selected, the terminal apparatus 3 transmits information (or signal) indicating that the “Releasing Service” is selected to the service server 5, in S319. In S320, the service server 5 which received the information transmitted in S319 transmits a releasing operation page, a list of video products (product list), and a list of image releasing servers. The releasing operation page is a page used for releasing operation by the user. The product list is a list of the video products registered in the product management database (DB) 72. The list of image releasing servers is a list of image releasing servers which can release the video product.

In S321, the terminal apparatus 3 displays the releasing operation page on the touch panel 44. In S322, the terminal apparatus 3 transmits information identifying a video product to be released selected on the releasing operation page, and information identifying an image releasing server for releasing the video product, to the service server 5. In S323, the service server 5 which received the information transmitted in S322 calculates a license fee for all the contents used for the video data included in the video product file corresponding to the video product selected through the terminal apparatus 3, and then transmits information on the calculated license fee to the terminal apparatus 3 (Information transmitting step). The license fee calculated in S323 does not include a license fee for the pay content used temporarily when editing or producing the video data in the process of the editing in S314 in the editing unit 62. That is, the license fee calculated in S323 does not include a license fee for the pay content which is combined with the video data under the editing and is subsequently removed from video data. The service server 5 calculates the license fee by referring a releasing fee for each content registered in the content management database 71.

In S324, the terminal apparatus 3 displays the calculated license fee and a screen for selecting whether or not the license fee is paid on the touch panel 44. In S325, the terminal apparatus 3 determines whether or not the payment of the license fee is selected (is agreed). If the payment of the license fee is not selected (is not agreed), the processing returns to S304. If the payment of the license fee is selected (is agreed), the terminal apparatus 3 transmits information indicating that the payment of the license fee is selected (is agreed) to the service server 5 in S326 (Agreement step).

In S327, the service server 5 which received the information transmitted in S326 transmits information on a bank account used for charge and information on a charged amount to the charging server 11 in order to charge the license fee for an account identified based on the member ID registered in the member management database 70 (Charging step). If the accounting in the charging server 11 is confirmed, the service server 5 transmits notification of the charging result to the terminal apparatus 3 in S328. In S329, the terminal apparatus 3 displays the notification of the charging result on the touch panel 44, and then the processing returns to S304. In S330, the service server 5 transmits the video data of the video product to be released (second video data) in the image releasing server 9 selected in S322 (Transmission step).

The low-quality content of which quality is reduced is used for the content combined with the video data in the process of editing. The service server 5 combines the original quality content (original content) with the video data, and thereby generates the video data to be released, before transmitting the video data to the releasing server in S330.

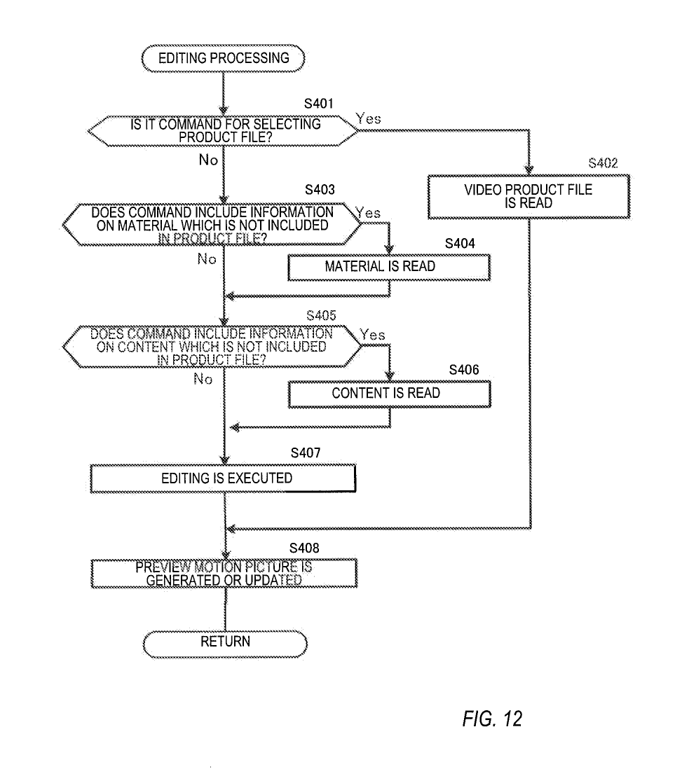

FIG. 12 is a flow chart showing editing processing executed by the editing unit 62 in the service server 5 in the process of editing in S314 (Editing step). In S401, the editing unit 62 determines whether the command received from the terminal apparatus 3 is the command to select the video product file. If the result of the determination in S401 is “YES (affirmation)”, the processing goes to S402. If the result of the determination in S401 is “NO (negation)”, the processing goes to S403. In S402, the editing unit 62 reads the video product file from the product memory 83b. For example, the command includes a product ID and a product file name as a parameter, and the editing unit 62 reads the video product file from the product memory 83b, referring the product directory stored in the product management database (DB) 72. The processing goes to S408, after completing the processing in S402.

In S403, the editing unit 62 determines whether the command received from the terminal apparatus 3 is a command to use a material which is not included in the video product file. If the result of the determination in S403 is “YES (affirmation)”, the processing goes to S404. If the result of the determination in S403 is “NO (negation)”, the processing goes to S405. In S404, the editing unit 62 reads the material corresponding to the information for identifying the material instructed in the command, from the product memory 83b.

In S405, the editing unit 62 determines whether the command received from the terminal apparatus 3 is a command to use a content which is not included in the video product file. If the result of the determination in S405 is “YES (affirmation)”, the processing goes to S406. If the result of the determination in S405 is “NO (negation)”, the processing goes to S407. In S406, the editing unit 62 reads the content corresponding to the information which identifying the content instructed in the command, from the content library 83a.

In S407, the editing unit 62 combines the material and/or content read out with video data, for example. Here, the editing unit 62 may delete an instructed part from the video data in accordance with an instruction of the command received from the terminal apparatus 3. The editing unit 62 reduces quality of the content through the quality reducing unit 63 (Quality reducing step), and then combines the low-quality content with the video product. When the content is an audio content, the quality reducing unit 63 may reduce a bandwidth of the audio content to a predetermined width. The quality reducing unit 63 may compress the content irreversibly (Data compression step), and then may decompress the irreversibly compressed content (Data decompression step). The processing goes to S408, after completing the processing in S407. In S408, the editing unit 62 generates or updates a preview motion picture for previewing the video data of the video product in course of the editing.

As mentioned above, in the present embodiment, the editing unit 62 (editing means) edits the material including at least one motion picture uploaded by the user through the network 13 and the content stored in the memory unit (external storage 7: storing means), in accordance with the user's operation through the terminal apparatus 3 connected to the network 13, and thereby produces the video data. The preview transmitting unit 75 (preview transmitting means) transmits the preview motion picture used for the preview of the video data produced by the editing unit 62 to the terminal apparatus 3 in order to reproduce as a preview with the terminal apparatus 3, in accordance with the user's operation through the terminal apparatus 3 connected to the network 13. The releasing unit 77 (releasing means) releases the video data produced by the editing unit 62 as a video product through the network 13. The charging unit 79 (charging means) charges the user operating the terminal apparatus 3 for a license fee for the pay content (original content).

According to the present embodiment, the communication unit 61 transmits and receives the information with regard to the editing through the network 13. The external storage 7 (memory unit) stores the content. The editing unit 62 edits the material including at least one motion picture uploaded through the network 13 and the content stored in the external storage 7 (memory unit), in accordance with the information indicating the editing operation by the user through the terminal apparatus 3 connected to the network 13, and thereby produces the video data. The quality reducing unit 63 produces the low-quality content based on the data generated by reducing the quality of the original content stored in the external storage 7 (memory unit). The editing unit 62 edits the material and the low-quality content, and thereby produces the first video data including the material and the low-quality content. Subsequently, the editing unit 62 produces the second video data including the material and the original content of the low-quality content. Accordingly, since only low-quality content is included in the first video data used for the preview, the high-quality pay content are not used without permission even when the first video data used for the preview are previewed in the terminal apparatus 3. Accordingly, it is allowed that the user tries plenty of preview contents. Furthermore, the low-quality content can be made free of charge.

According to the present embodiment, the communication unit 61 receives the signal, which is a signal transmitted from the terminal apparatus 3 and is corresponding to the user's operation detected by the predetermined program executed by the terminal apparatus 3, as the information with regard to the above-mentioned editing. In accordance with the signal corresponding to the user's editing operation, the editing unit 62 edits the material and the low-quality content, and thereby produces the first video data. Accordingly, the user can edit and produce video data suitably by operation in the terminal apparatus 3 through the operation unit 49.

According to the present embodiment, the predetermined program is a Web browser for displaying the Web page in the terminal apparatus 3, and the server apparatus 8 further includes the Web page generation unit 69 (Web page generating means) for generating the Web page displayed on the terminal apparatus 3, for example. The Web page generation unit 69 generates the Web page used for operating the editing unit 62 of the server apparatus 8. The communication unit (communication interface 61) transmits the Web page generated for operating the editing unit 62 of the server apparatus 8 to the terminal apparatus 3. In this case, the user can suitably edit and produce the video data by using an already-existing Web browser.

According to the present embodiment, the charging unit 79 charges the user for the license fee for the content. The charging unit 79 charges the license fee for the original content used for the second video data to be released, but does not charge the license fee for the low-quality content used when the editing unit 62 produces the first video data for preview in the process of the editing. Accordingly, the user does not need to purchase any content at the time of the editing of the motion picture (video data).

According to the present embodiment, when the pay content is an audio content, for example, the quality reducing unit 63 produces the low-quality audio content based on data generated by reducing a bandwidth of the audio data. The editing unit 62 edits the material and the low-quality audio content in the process of editing, and thereby produces the first video data. In this case, quality of the audio pay content can be simply reduced to predetermined low quality by using an already-existing filter. Moreover, the quality reducing unit 63 includes the data compression unit and the data decompression unit, for example. The quality reducing unit 63 reduces quality of the content by compressing irreversibly the pay content through the data compression unit, and then decompressing the irreversibly compressed data through the decompression unit. The editing unit 62 combines the material with the low-quality content in the process of editing, and thereby produces the first video data used for the preview. In this case, the pay content is simply reduced to predetermined low quality by using an already-existing data compression and decompression technology.

According to the present embodiment, the server apparatus 8 further includes: the member management database 70 for registering the member information including account information; and the authentication unit (CPU 67) for authenticating the member based on the member information registered in the member management database 70. The user of the terminal apparatus 3 is a member authenticated by the authentication unit, and therefore the charging unit 79 charges the member therefor. Accordingly, the user of the terminal apparatus 3 who uses the server apparatus 8 can be limited to the specific member.

According to the present embodiment, the charging unit 79 may charge the dues-paying member for a predetermined membership fee for every predetermined period as a license fee for the pay content used for the released second video data. Accordingly, the charging unit 79 does not charge the free member therefor.

Embodiments of this invention were described above, but the above embodiments are merely examples of applications of this invention, and the technical scope of this invention is not limited to the specific constitutions of the above embodiments.

The present application claims priority based on Japanese Patent Application No. 2011-272621 filed with the Japan Patent Office on Dec. 13, 2011, the entire contents of which are hereby incorporated by reference into this specification.

What is claimed is:

1. A server apparatus for editing a motion picture received through a network, the server apparatus comprising:
a communication unit to transmit and receive information with regard to editing through the network;
a memory unit to store at least one content;
an editing unit to produce video data by editing a material which is including at least one motion picture and is uploaded through the network and the content stored in the memory unit, in accordance with the information indicating editing operation of a user in a terminal apparatus connected to the network; and
a quality reducing unit to produce a low-quality content by reducing quality of a high-quality original content stored in the memory unit, wherein
the editing unit produces first video data by editing the material and the low-quality content, and then produces second video data including the material and the original content of the low-quality content.

2. The server apparatus according to claim 1, wherein
the communication unit receives a signal corresponding to editing operation by a user detected by a program executed in the terminal apparatus, the signal being transmitted from the terminal apparatus as information with regard to the editing, and
the editing unit produces the first video data by editing the material and the low-quality content in accordance with the signal corresponding to the editing operation by the user.

3. The server apparatus according to claim 2, wherein
the program is a Web browser for displaying a Web page on the terminal apparatus,
the server apparatus further comprising a Web page generation unit to generate the Web page displayed on the terminal apparatus by the program, wherein
the Web page generation unit generates the Web page for controlling the editing unit of the server apparatus, and the communication unit transmits the generated Web page as information with regard to the editing to the terminal apparatus.

4. The server apparatus according to claim 3 further comprising a charging unit to charge the user for a license fee for the content, wherein
the charging unit charges the user for a license fee for the original content used for the second video data, but does not charge the user for a license fee for the low-quality content used when producing the first video data in the process of the editing in the editing unit.

5. The server apparatus according to claim 4 further comprising:
a member management database to register member information including account information for the member; and
an authentication unit to authenticate the member based on the member information registered in the member management database, wherein
the user is a member authenticated by the authentication unit, and the charging unit charges the member for the license fee.

6. The server apparatus according to claim 1, wherein
the original content is an audio content,
the quality reducing unit produces a low-quality audio content based on data generated by reducing a bandwidth of the audio content, and
the editing unit produces the first video data by editing the material and the low-quality audio content in the process of the editing.

7. The server apparatus according to claim 1, wherein
the quality reducing unit comprises a data compression unit and a data decompression unit, and reduces the quality of the original content by compressing irreversibly the original content through the data compression unit, and then decompressing the irreversibly compressed original content through the data decompression unit, and
the editing unit produces the first video data by combining the material and the low-quality content in the process of the editing.

8. A method for producing a video product in a server apparatus connected to a terminal apparatus through a network, the method comprising:
an uploading step of uploading a material including at least one motion picture to the server apparatus through the network;
a selecting step of selecting a desired original content from a list of contents stored beforehand in the server apparatus in accordance with operation by a user on the terminal apparatus;
an editing step of producing first video data by editing the material and a low-quality content generated from the selected original content in accordance with operation by the user on the terminal apparatus; and
a combining step of producing second video data corresponding to the first video data by combining the material used for the first video data with the original content which is a source of the low-quality content in accordance with operation by the user on the terminal apparatus.

9. The method according to claim 8 further comprising a receiving step of receiving a signal corresponding to the operation by the user detected by a predetermined program executed in the terminal apparatus, wherein
in the editing step, the first video data is produced by editing the material with the low-quality content of the selected original content in accordance with the signal received in the receiving step, and the produced first video data is transmitted to the terminal apparatus in order to display the produced first video data on the terminal apparatus.

10. The method according to claim 9 further comprising a Web page transmitting step of generating a Web page and transmitting the generated Web page to the terminal apparatus, wherein
the program executed in the terminal apparatus is a Web browser for displaying the Web page generated and transmitted in the Web page transmitting step, and
the Web page controls the editing step in the server apparatus.

11. The method according to claim 10 further comprising a charging step of charging the user for a license fee for the content, wherein
in the charging step, a license fee for the original content used for the second video data is charged for the user, but a license fee for the low-quality content used when producing the first video data is not charged for the user.

12. The method according to claim 11 further comprising a member registration step of registering member information including account information for the user in a member management database, before the uploading step, wherein
the user is a member whose member information is registered in the member registration step, and
the license fee for the original content used for the second video data is charged for the registered member in the charging step.

13. The method according to claim 11 further comprising a quality reducing step of producing a low-quality content by reducing quality of the original content selected in the selecting step, wherein
in the editing step, the first video data are produced by combining the material and the low-quality content produced in the quality reducing step.

14. The method according to claim 13, wherein
the original content is an audio content, and a low-quality audio content is produced based on data generated by reducing a bandwidth of the audio content to a predetermined bandwidth in the quality reducing step, and
the first video data are produced by editing the material and the low-quality audio content in the editing step.

15. The method according to claim 13, wherein
the quality reducing step includes a data compression step and a data decompression step,
a low-quality audio content is produced by compressing irreversibly the original content in the data compression step, and then decompressing the irreversibly compressed original content in the data decompression step, and
the first video data are produced by editing the material and the low-quality audio content in the editing step.
